(19) United States
(12) Patent Application Publication
(10) Pub. No.: US 2007/0250425 A1
(43) Pub. Date: Oct. 25, 2007

(54) Synthetic stock repurchase

(75) Inventors: Crawford Jamieson, Hong Kong (HK); George Liu, Central (HK); Nathan McMurtray, Hong Kong (HK)

Correspondence Address: KIRKPATRICK & LOCKHART PRESTON GATES ELLIS LLP, 535 SMITHFIELD STREET, PITTSBURGH, PA, 15222, US

(73) Assignee: Morgan Stanley

(21) Appl. No.: 11/409,924

(22) Filed: Apr. 24, 2006

(51) Int. Cl. G06Q 40/00

(52) U.S. Cl. 705/36 R

(57) ABSTRACT

A capital structure is provided for use in association with shares of an issuer, such as shares of common stock. The capital structure may include a share-purchasing entity structured to issue at least one security to the issuer and to receive proceeds in return for the security. In addition, the share-purchasing entity may have a business purpose limited to issuing the security to the issuer, owning the shares of the issuer, or purchasing the shares of the issuer. The share-purchasing entity may also be structured to use proceeds received from issuance of the security, or from dividends paid on the shares of the issuer, for purchasing shares of the issuer.

### BACKGROUND

Companies frequently elect to return capital to their common stockholders through dividend payments or by repurchasing shares of their outstanding common stock. However, the extent to which capital may be returned through dividends and/or share repurchases is typically limited by corporate law. Often this limitation takes the form of a requirement that a company can only distribute dividends or repurchase shares up to the amount of current profits or retained earnings. For certain companies, particularly those that already pay a large dividend or that lack current profits, these legal requirements can significantly constrain their flexibility to manage their capital structures. Corporate law or the constitutive documents of a company may also impose various corporate governance steps, such as the need to get board or even shareholder approval of the intended dividend distribution or share repurchase. Shareholder approval in particular can be difficult, expensive and/or time-consuming to obtain even if the proposal is favored by shareholders, due to the need to notify individuals and solicit a response.

In addition to corporate law and corporate governance requirements, both dividends and share repurchases are affected by various regulatory and procedural constraints. For instance, before a listed company can pay a dividend to its shareholders, it must establish a record date to determine which shareholders will be entitled to the dividend. Selection of the record date is subject to rules imposed by the various stock exchanges governing the amount of prior notice provided to the exchange and similar procedures. Similarly, share repurchases are typically subject to regulation by securities regulators in the jurisdictions where the company is domiciled and/or the stock trades. Often securities exchanges on which the stock is listed impose their own rules as well, which may or may not harmonize with rules imposed by regulators or other exchanges. Examples of such rules include requirements that a company purchasing its own shares do so only through local brokers or over a particular securities exchange, or at certain times and prices, or through other means (e.g. a mandatory tender offer). For both dividends and share repurchases, these regulatory and procedural constraints may further impede a company's ability to manage its capital structure or achieve its desired timing goals in returning capital to its shareholders.

Other, non-regulatory constraints often apply to dividends and share repurchases as well. For example, companies that issue debt securities or borrow money from banks often find that covenants in the debt securities or the terms of the loan agreements limit or even prohibit dividend payments or repurchases of common stock. Other activities undertaken by a company, such as entering merger or acquisition discussions, can create situations in which the company possesses material non-public information that for business reasons it does not want to disclose; and thus the company cannot repurchase its shares potentially for an extended period of time, as such purchase would be deemed insider trading in many jurisdictions. Less tangible concerns, such as the general belief that reduction of a dividend is a negative signal to investors about a company's financial well-being or near-term share price, may also cause companies to be hesitant to return capital through dividend payments.

In view of the foregoing problems, development of improved structures and methods that can expand capital management capabilities and enhance capital return opportunities would be beneficial to companies that issue stock and their shareholders.

### SUMMARY

Embodiments of the invention provide a capital structure for use in association with shares of an issuer, such as shares of common stock. The capital structure may include a share-purchasing entity structured to issue at least one security to the issuer and to receive proceeds (e.g., cash) in return for the security. In addition, the share-purchasing entity may have a business purpose limited to issuing the security to the issuer, owning the shares of the issuer, or purchasing the shares of the issuer. The share-purchasing entity may also be structured to use proceeds received from issuance of the security for purchasing shares of the issuer.

In certain embodiments of the invention, the security may be a debt security with characteristics including no fixed maturity date and/or no interest or yield. The debt security may also be convertible at the option of the issuer into an ownership interest in the share-purchasing entity, and the ownership interest may comprise a majority interest in the share-purchasing entity.

In various embodiments, the share-purchasing entity is not owned or directly controlled by the issuer and may be established with an off-shore or on-shore domicile with respect to the domicile of the issuer. The share-purchasing entity may be structured to use dividend proceeds from shares of the issuer to purchase additional shares of the issuer. In addition, the share-purchasing entity may be acquired at the option of the issuer through exercise of a conversion right in the securities issued to the issuer by the share-purchasing entity.

### BRIEF DESCRIPTION OF THE FIGURES

The utility of the embodiments of the invention will be readily appreciated and understood from consideration of the following description of the embodiments of the invention when viewed in connection with the accompanying drawings.

FIG. 1 includes a schematic that illustrates an example of a capital structure that may be provided in accordance with various embodiments of the invention;

FIG. 2 includes a process flow diagram that illustrates examples of transactions or method steps that may be conducted in accordance with various embodiments of the invention; and,

FIG. 3 includes a schematic that illustrates examples of communication and processing systems that may be provided in accordance with various embodiments of the invention.

### DESCRIPTION

As applied herein, the term “issuer” may include a company, corporation, firm, institution, or other entity capable of issuing shares to shareholders.

The term “share” may include any stock, instrument or unit issued by an issuer that represents an ownership interest in the issuer. An example of one type of “share” is a share of common stock issued by a corporation (i.e., the issuer) to a shareholder.

The term “share-purchasing entity” may include a company, corporation, firm, institution, or other entity capable of purchasing, selling or exchanging shares of an issuer. An example of one type of a “share purchasing entity” is a limited liability company (LLC).

As applied herein, the term “rules” is intended to broadly encompass laws, regulations, ordinances, policies, guidelines and/or other rules of various local, national, regional or international jurisdictions that may be applicable to various embodiments of the invention. Examples of types of “rules” that may be applicable to the structures and methods described herein include, without limitation, accounting rules, tax rules, and corporate rules.

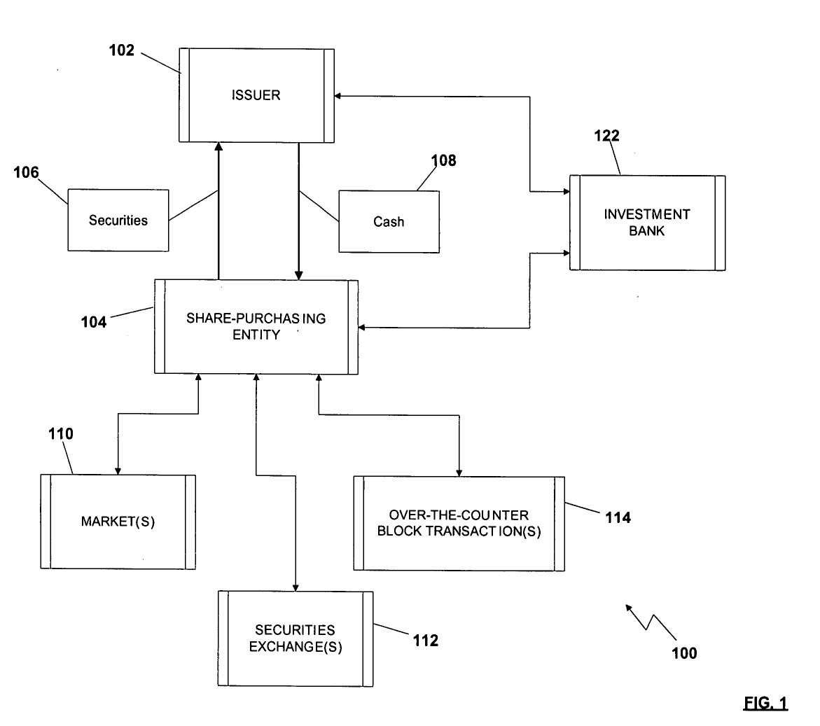

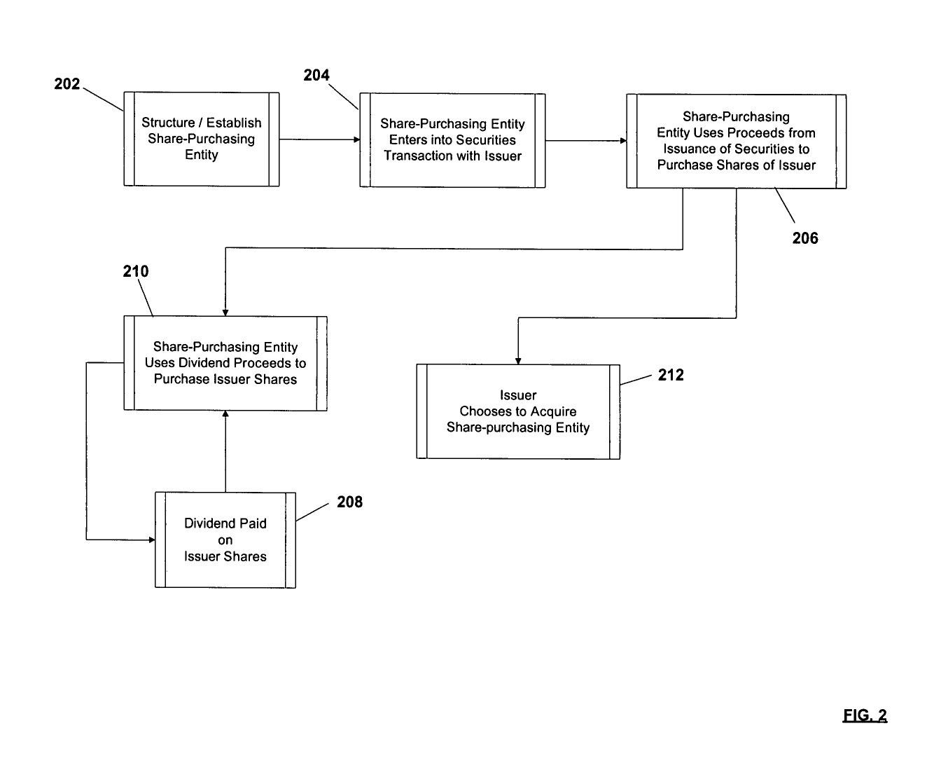

With reference to FIGS. 1 and 2, in various embodiments of the invention, a capital structure 100, and an associated method for structuring and using the capital structure 100, can be provided to allow an issuer 102 to return capital to shareholders of the issuer 102. As described below, the capital structure 100 may be configured to function in a manner substantially similar to a share repurchase program, for example, employed by the issuer 102 to repurchase its own shares (e.g., common stock shares). As demonstrated in various embodiments described herein, however, the capital structure 100 does not require the actual repurchase of shares by the issuer 102.

At step 202, a special purpose vehicle or share-purchasing entity 104 can be established which is structured to conduct securities transactions with the issuer 102. The share-purchasing entity 104 may be formed as a limited liability company, for example, or a variety of other structurally suitable entities. At the time of its formation, the share-purchasing entity 104 may be structured to be not owned or not controlled directly by the issuer 102. The constitutive documents (charter, bylaws, etc.) of the share-purchasing entity 104 can be structured to prohibit the share-purchasing entity 104 from engaging in business purposes other than: (i) issuing securities 106 to the issuer 102 in exchange for cash 108 or cash equivalent proceeds, (ii) purchasing shares of the issuer 102; and/or, (iii) owning shares of the issuer 102. In various embodiments, the domicile of the share-purchasing entity 104 may be established as off-shore or on-shore with respect to the domicile of the issuer 102, depending on applicable jurisdictional rules.

At step 204, the issuer 102 may enter into a securities transaction with the share-purchasing entity 104, wherein the issuer 102 purchases securities 106 issued by the share-purchasing entity 104 with cash 108 or cash equivalent finds. In various embodiments, the securities 106 of the share-purchasing entity 104 may be debt securities configured with one or more of the following characteristics: no fixed maturity date; pay no interest or yield; and/or, convertible at the option of the issuer 102 into ownership interests in the share-purchasing entity 104. It can be appreciated by the skilled artisan that structuring the securities 106 as perpetual debt securities, or with no fixed maturity date, may afford beneficial treatment under certain accounting rules. Such beneficial treatment may include accounting for the securities 106 at acquisition cost and not engaging in mark-to-market valuation of the securities 106 over time, which can result in reduced volatility for the income statement of the issuer 102. It can also be appreciated that configuring the securities 106 with a zero yield, zero coupon feature can result in tax benefits to the issuer 102. For example, such tax benefits may be realized in the form of avoiding dividend tax leakage and/or avoiding characterization of the securities 106 as participating securities, which might require accounting treatment of the securities 106 under an undesirable two-class method.

In certain embodiments, depending on the applicable rules of specific jurisdictions, the securities 106 may be configured with a debt component and a warrant component having an option to purchase shares of the issuer 102. For example, certain jurisdictions (such as Taiwan) may restrict the ability of an on-shore privately held share-purchasing entity 104 to issue convertible securities to the issuer 102. In such jurisdictions, the share-purchasing entity 104 may be constituted with the limited business purpose of issuing securities 106 to the issuer 102 in exchange for cash, and purchasing and owning shares of the issuer 102; but the share-purchasing entity 104 can also be structured to issue the securities 106 with a debt component and a warrant instead of the convertible debt security described above, for example.

At step 206, following the sale of the securities 106 to the issuer 102, the share-purchasing entity 104 may use the cash 108 obtained from the issuer 102 to purchase shares of the issuer 102, which may be in the form of common stock of the issuer 102, for example. Such purchases may be made on one or more markets 110, over one or more securities exchanges 112, in over-the-counter block transactions 114, and/or in any other conventional manner. Purchases of shares of the issuer 102 may occur immediately or over a period of time. From a corporate law perspective, the use of the share-purchasing entity 104 to purchase shares of the issuer 102 may provide an alternative to rules in certain jurisdictions that prohibit an issuer 102 from purchasing its own stock, for example.

At step 210, in the event that the issuer 102 pays a cash dividend on its shares at step 208, for example, the share-purchasing entity 104 can be structured to use cash proceeds it receives from the dividends paid on the shares of the issuer 102 it owns to purchase additional shares of the issuer 102. Such purchases may be made on the markets 110, over the securities exchanges 112, in the over-the-counter block transactions 114, and/or in any other conventional manner. It can be seen that this function performed in step 210 has an effect similar to the reinvestment of dividends in shares of the issuer 102 and results in the return of additional capital to shareholders of the issuer 102. Cash received by the share-purchasing entity 104, other than amounts that may be required for operating expenses, for example, may be used for such purchases of the shares of the issuer 102.

Optionally, at step 212, the issuer 102 may choose to acquire the share-purchasing entity 104 by exercising its right to convert the securities 106 purchased from the share-purchasing entity 104 into a controlling ownership interest in the share-purchasing entity 104. The structure 100 may be configured, however, such that the issuer 102 is not required to acquire the share-purchasing entity 104, and the issuer 102 may in fact never choose to do so. Upon conversion of the securities 106, corporate law in the relevant jurisdiction may permit the issuer 102 to effect a statutory merger, a share swap, or a structurally similar transaction to obtain direct ownership of the assets of the share-purchasing entity 104. It can be seen that the primary assets, and perhaps only assets, of the share-purchasing entity 104 are the shares of the issuer 102. The act of converting the securities 106 thus results in retirement of the shares of the issuer 102 acquired through the business operations of the share-purchasing entity 104. This acquisition of the issuer's 102 shares following the exercise of the conversion right of the securities 106 and the subsequent merger are typically treated as incidental to the acquisition of another entity rather than as a share repurchase by the issuer 102. Thus, corporate law restrictions usually associated with share repurchases (such as limitations based on current profits or retained earnings) should not be applicable to the merger of the share-purchasing entity 104 into the issuer 102 in many jurisdictions.

In most jurisdictions, neither the purchase or sale of the securities 106 by the issuer 102 and the share-purchasing entity 104, respectively, nor the purchases of the common stock by the share-purchasing entity 104 result in tax being payable by either the issuer 102 or the share-purchasing entity 104. However, shareholders that sell their shares to the share-purchasing entity 104 may be liable for tax depending on the laws of the relevant jurisdiction. Moreover, dividend payments by the issuer 102 on its common stock are generally taxable under the tax rules of various jurisdictions. In many cases, selecting a domicile for the share-purchasing entity 104 that has a favorable tax treaty with the issuer's 102 domicile will minimize this potential tax exposure.

The accounting treatment for the transaction depends on the accounting rules applicable to the various entities involved in the transactions. If the issuer 102 uses IFRS accounting, for example, it can account for the debt securities 106 it purchases as held-to-maturity long term investments carried at cost, which will not be subject to mark-to-market changes in value. The issuer's 102 earnings per share (EPS) calculations will not be affected (positively or negatively) by the transactions as the common stock has not been retired for accounting purposes. However, investors and equity research analysts are likely to view such common stock as no longer outstanding since the share-purchasing entity 104 may be structured to be incapable of selling or disposing of it and must purchase more stock with cash it receives, making such stock essentially no longer outstanding for their purposes. The share-purchasing entity's 104 accounting treatment for the common stock purchased by it is irrelevant (though likely to be carried at the lower of cost or market), since neither the share-purchasing entity 104 nor the common stock is owned by the issuer 102 and the assets and liabilities of the share-purchasing entity 104 are not consolidated with the issuer 102.

For corporate law purposes, the transaction will not be treated as the repurchase of stock by the issuer 102 in most jurisdictions. This occurs because initially the issuer 102 does not own the share-purchasing entity 104 or its assets. It has made an investment in the share-purchasing entity 104, but not one that has resulted in or is certain to result in ownership of the share-purchasing entity 104 or its assets, since conversion is at the issuer's 102 option and may never occur. This is in contrast to structures that involve the immediate direct purchase of securities convertible or exchangeable into shares of the issuer's 102 own common stock and hence are typically viewed as a repurchase for corporate law purposes. Moreover, in embodiments of the invention, securities 106 initially purchased by the issuer 102 can be structured to be convertible not into the issuer's 102 own shares, but into ownership interests in an unrelated entity (i.e., the share-purchasing entity 104).

In various embodiments of the invention, an investment bank 122 may work with the issuer 102 or the share-purchasing entity 104 to facilitate creation of the capital structures described herein and/or to facilitate performance of the above-described method steps. For example, the investment bank 122 may assist in creation and establishment of the share-purchasing entity 104, including the constitutive documents of the share-purchasing entity 104. The investment bank 122 may assist the share-purchasing entity 104 with subsequent purchases of shares of the issuer 102 using dividends received from the issuer 102 shares. The investment bank 122 may also arrange for the merger of the share-purchasing entity 104 into the issuer 102, in the event that the issuer 102 elects to exercise conversion rights provided by the securities 106 issued by the share-purchasing entity 104.

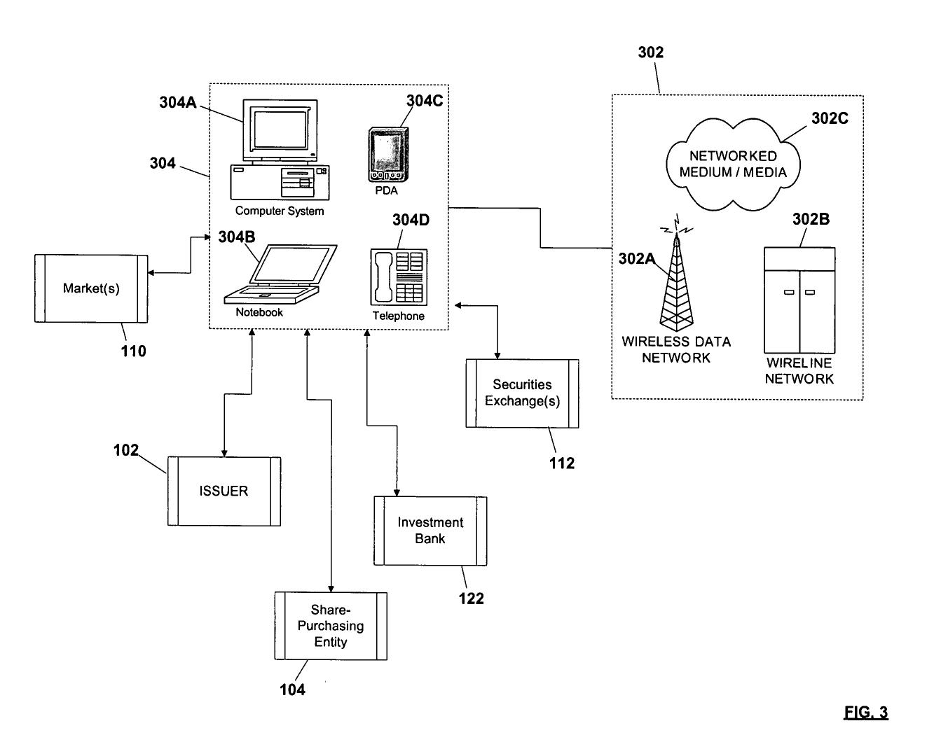

With reference to FIG. 3, in various embodiments of the invention, the various entities involved in the structures, transactions and method steps described above may communicate through various communication media 302 by using one or more types of access devices 304. As shown, examples of suitable communication media 302 include, without limitation, a wireless data network 302A, a wireline network 302B, and a variety of networked media 302C (e.g., an intranet or the Internet). In addition, examples of suitable access devices 304 include, without limitation, a computer system 304A, a notebook computer 304B, a personal data assistant (“PDA”) 304C, and a telephone 304D (of either wireless or wireline variety). In operation, for example, the issuer 102 may communicate with or exchange data with the share-purchasing entity 104 over a networked medium 302C using a computer system 304A in conjunction with many of the transactions described herein.

In developing the various embodiments of the invention, the inventors have recognized and addressed previous attempts by issuers to address their capital structure problems. Such attempts often involve structures and methods that use equity-linked securities or equity derivatives to achieve return of capital goals. For instance, an issuer may elect to repurchase outstanding convertible debt securities it had previously issued and thereby reduce the number of shares of common stock potentially outstanding. Because the accounting rules in many jurisdictions require treating the common stock underlying convertible debt securities as outstanding for accounting purposes even though conversion has not occurred, repurchasing these securities achieves a reduction in the amount of shares deemed outstanding. Equity research analysts and investors often follow a similar methodology in their analysis of an issuer, since they generally want their results to match those of the accountants. However, simply repurchasing outstanding convertible debt securities typically does not address the corporate law or regulatory issues discussed above as many jurisdictions view this as equivalent to the direct repurchase of shares by the issuer. Moreover, the accounting treatment of the transaction can vary depending on the repurchase price and may not substantially replicate the treatment afforded to an ordinary share repurchase.

In addition, because convertible debt securities often contain features more valuable to investors than just the underlying common stock (such as coupon payments, put rights, and the ability to be repaid at maturity regardless of the prevailing stock price), the market price of the convertible debt securities often exceeds the price of the underlying stock. This means that the economics of the transaction may not match those of an ordinary share repurchase, and achieving the same reduction of capital through convertible debt repurchase may be significantly more expensive than through ordinary share repurchase.

This previously attempted method is further constrained by the necessity for a convertible debt security to be outstanding in order for it to be repurchased, which limits the availability of the method to companies that have previously issued convertible debt. This last constraint is sometimes avoided through a similar method involving the issuer purchasing an exchangeable debt security created specifically for this purpose by an investment bank or brokerage firm. In this method, the investment bank or brokerage firm first acquires shares of the issuer's stock (often by purchasing it on a securities exchange at prevailing market prices) and then uses these shares to underlie a debt security that is exchangeable into the underlying shares at the holder's option. By selling this newly created exchangeable debt security to the issuer, a repurchase situation can be achieved despite the lack of previously issued convertible debt securities, with the additional benefit that the exchangeable debt security can be designed to minimize the cost in excess of the value of the underlying shares (since coupons, put rights, etc. can be omitted). A similar situation can be effected through an equity derivative such as a call right or forward purchase contract purchased by the issuer from the investment bank or brokerage firm and hedged by the investment bank or brokerage firm with shares of the issuer.

These previously attempted methods have not been widely adopted, however, because in certain jurisdictions they do not address restrictions imposed by corporate law. Corporate law in many jurisdictions views the purchase of the exchangeable debt security or equity derivative by the issuer as equivalent to a direct purchase of the issuer's own shares. This means that the issuer must comply with limitations on amount and the necessary corporate governance process, just as if an ordinary share repurchase program had been undertaken.

It has been demonstrated that embodiments of the present invention can provide a capital structure for an issuer 102 to return capital to its shareholders in a manner similar to repurchasing its own shares but without necessitating the actual repurchase of common shares by the issuer 102. According to various embodiments, the issuer 102 may enter into a transaction with a share-purchasing entity 104, whereby the issuer 102 purchases convertible debt securities 106 of the share-purchasing entity 104 in return for cash. The share-purchasing entity 104 may be specially formed for this limited business purpose and may be structured to be not owned or controlled by the issuer 102. The convertible debt securities 106 may be structured to have no fixed maturity date, to not pay interest, and may be converted by the issuer 102 into ownership interests in the share-purchasing entity 104 at any time. The share-purchasing entity 104 may use the cash obtained from the sale of the convertible debt securities 106 to the issuer 102 to purchase shares of the issuer's 102 common stock, for example, in open market purchases or through other means. If the issuer 102 pays dividends on its common stock, the share-purchasing entity 104 can use the cash received from such dividends to purchase additional shares of common stock of the issuer 102. The share-purchasing entity 104 is prohibited or limited in its constitutive documents from engaging in any business activities other than owning, acquiring or selling shares of common stock of the issuer 102. Subsequently, the issuer 102 may decide to exercise its right to convert the convertible debt securities 106 into a controlling interest in the share-purchasing entity 104 and thereafter acquire or merge with the share-purchasing entity 104. This synthetically produces an effect similar to a conventional share repurchase program but without direct repurchase of shares by the issuer 102.

Embodiments of the invention provide flexibility with respect to an issuer's corporate governance, since the transactions described herein can be directed by the issuer's management team without the necessity of shareholder approval, and in many cases without board approval. Moreover, many securities regulators and securities exchanges are less stringent in the application of rules to purchases of common stock by third parties in comparison to an issuer purchasing its own common stock. For example, mandatory tender offers, use of particular brokers or exchanges, and price or time restrictions are limitations that are unlikely to apply to various embodiments of the invention.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media. In general, a computer-readable medium may include any medium capable of being a carrier for an electronic signal representative of data stored, communicated or processed in accordance with embodiments of the present invention. Where applicable, method steps described herein may be embodied or executed as instructions (e.g., software or firmware) stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

What is claimed is:

1. A capital structure for use in association with an issuer capable of issuing one or more shares, the capital structure comprising:
a share-purchasing entity structured to issue at least one security to the issuer and to receive proceeds in return for the security; and,
wherein a business purpose of the share-purchasing entity is limited to issuing the security to the issuer, owning the shares of the issuer, or purchasing the shares of the issuer, wherein the share-purchasing entity is structured to use the proceeds received from issuance of the security for purchasing shares of the issuer.

2. The capital structure of claim 1, wherein at least one share of the issuer includes common stock.

3. The capital structure of claim 1, wherein the share-purchasing entity includes a limited liability company.

4. The capital structure of claim 1, wherein the share-purchasing entity is structured to be not owned or directly controlled by the issuer.

5. The capital structure of claim 1, further comprising the share-purchasing entity being established in one of an off-shore domicile or an on-shore domicile with respect to the domicile of the issuer.

6. The capital structure of claim 1, wherein the security issued by the share-purchasing entity includes a debt security.

7. The capital structure of claim 6, wherein the debt security has no fixed maturity date.

8. The capital structure of claim 6, wherein the debt security pays no interest or yield.

9. The capital structure of claim 6, wherein the debt security is convertible at the option of the issuer into an ownership interest in the share-purchasing entity.

10. The capital structure of claim 9, wherein the ownership interest comprises a majority interest in the share-purchasing entity.

11. The capital structure of claim 1, wherein the security issued to the issuer by the share-purchasing entity includes a debt component and a warrant component.

12. The capital structure of claim 1, further comprising the share-purchasing entity being structured to use dividend proceeds from shares of the issuer to purchase additional shares of the issuer.

13. The capital structure of claim 1, wherein the share-purchasing entity is acquirable at the option of the issuer.

14. A capital structure for use in association with an issuer capable of issuing one or more shares, the capital structure comprising:
a share-purchasing entity structured to issue at least one debt security to the issuer and to receive proceeds in return for the debt security, the debt security being convertible at the option of the issuer into an ownership interest in the share-purchasing entity; and,
wherein a business purpose of the share-purchasing entity is limited to issuing the security to the issuer, owning the shares of the issuer, or purchasing the shares of the issuer, wherein the share-purchasing entity is structured to use the proceeds received from issuance of the security for purchasing shares of the issuer.

15. The capital structure of claim 14, further comprising the share-purchasing entity being structured to use dividend proceeds from shares of the issuer to purchase additional shares of the issuer.

16. The capital structure of claim 14, wherein the share-purchasing entity is acquirable at the option of the issuer.

17. A capital structure for use in association with an issuer capable of issuing one or more shares of common stock, the capital structure comprising:
a share-purchasing entity structured to issue at least one debt security to the issuer and to receive cash proceeds in return for the debt security, the debt security having no fixed maturity date, the debt security having no yield, the debt security being convertible at the option of the issuer into a majority ownership interest in the share-purchasing entity;
wherein a business purpose of the share-purchasing entity is limited to issuing the security to the issuer, owning shares of common stock of the issuer, or purchasing shares of common stock of the issuer, wherein the share-purchasing entity is structured to use the cash proceeds received from issuance of the security for purchasing common stock shares of the issuer;
the share-purchasing entity being structured to be not owned or directly controlled by the issuer;
the share-purchasing entity being structured to use dividend proceeds from the common stock shares of the issuer to purchase additional common stock shares of the issuer; and,
wherein the share-purchasing entity is acquirable at the option of the issuer.

18. A method for structuring a capital structure for use in association with an issuer capable of issuing one or more shares, the method comprising:
establishing a share-purchasing entity to issue at least one security to the issuer and to receive proceeds in return for the security; and,
structuring a business purpose of the share-purchasing entity to be limited to issuing the security to the issuer, owning the shares of the issuer, or purchasing the shares of the issuer, wherein the share-purchasing entity is structured to use the proceeds received from issuance of the security for purchasing shares of the issuer.

19. The structuring method of claim 18, further comprising establishing the share-purchasing entity with an off-shore domicile.

20. The structuring method of claim 18, wherein the security issued by the share-purchasing entity includes a debt security.

21. The structuring method of claim 20, further comprising structuring the debt security to be convertible at the option of the issuer into an ownership interest in the share-purchasing entity.

22. The structuring method of claim 18, further comprising structuring the share-purchasing entity to use dividend proceeds from shares of the issuer to purchase additional shares of the issuer.
